(19) United States
(12) Patent Application Publication
(10) Pub. No.: US 2024/0402636 A1
(43) Pub. Date: Dec. 5, 2024

(54) IMAGE FORMING APPARATUS

(71) Applicant: CANON KABUSHIKI KAISHA, Tokyo (JP)

(72) Inventor: EIKOU MORI, Tokyo (JP)

(21) Appl. No.: 18/674,494

(22) Filed: May 24, 2024

(30) Foreign Application Priority Data
May 29, 2023 (JP) 2023-088267

(51) Int. Cl. G03G 15/23; B41J 3/60; B41J 11/00; B41J 13/08; B41J 13/26; B65H 5/22; B65H 9/00; G03G 15/00

(52) U.S. Cl. CPC G03G 15/234; B41J 3/60; B41J 11/0085; B41J 11/0095; B41J 13/08; B41J 13/26; B65H 5/224; B65H 9/002; G03G 15/50; G03G 15/6529; B65H 2701/1311; B65H 2701/1313

(57) ABSTRACT

An image forming apparatus that forms images on both surfaces of a sheet includes registration sensors that detect the sheet conveyed by a conveyance roller pair, a registration unit that controls an orientation of the sheet, an in-line scanner unit that reads the sheet, another conveyance roller pair that conveys the sheet switched back by a reversing unit, to the conveyance roller pair, and a controller that controls duplex printing. When an image is formed on a second surface of the sheet after an image is formed on a first surface of the sheet, the controller controls the orientation of the sheet on which an image is to be formed on the second surface, based on an inclination of a leading and a trailing edge of the sheet detected by the in-line scanner unit, and an inclination of the leading edge of the sheet detected by the registration sensors.

### BACKGROUND OF THE INVENTION

### Technical Field

The present invention relates to print position control for adjusting an image formation position of an image to be formed on a sheet by an image forming apparatus.

### Description of the Related Art

There is known a technique for an image forming apparatus that forms images on sheets controlling conveyance positions of a sheet on which images are to be formed to be target positions, to align the positions of one image to be formed on the front surface of the sheet and the other image to be formed on the rear surface of the sheet. An image forming apparatus discussed in United States Patent Application Publication No. 2009/0134569 sets one side (will be referred to as a reference side) of a sheet as a reference, and controls the position of the sheet in a direction orthogonal to the conveyance direction in which the sheet is conveyed, in such a manner that the reference side reaches a target position.

On the other hand, sheets have cutting errors in different manufacturing lots, producing differences in shape of sheets. Furthermore, the shape of sheets varies due to the environment (e.g., temperature and humidity) where the sheets are stored. Thus, with a sheet whose shape is different from an ideal rectangle, one reference side of the sheet set to form an image on the front surface and another reference side of the sheet set to form an image on the rear surface are not parallel.

The image forming apparatus discussed in United States Patent Application Publication No. 2009/0134569 cannot accurately control relative positions of an image on the front surface and an image on the rear surface due to the shape of the sheet. With one reference side of a sheet set to form an image on the front surface and another reference side of the sheet set to form an image on the reverse surface not parallel, the image on the front surface and the image on the rear surface are not aligned.

### SUMMARY OF THE INVENTION

According to an aspect of the present invention, an image forming apparatus that forms images on both surfaces of a sheet includes a first conveyance unit configured to convey a sheet, an orientation control unit configured to control an orientation of the sheet conveyed by the first conveyance unit, an image forming unit configured to form an image on the sheet of which the orientation is controlled by the orientation control unit, a first sensor configured to detect the sheet while the sheet is conveyed by the first conveyance unit, the first sensor being used to detect an inclination of a leading edge of the sheet in a conveyance direction in which the sheet is conveyed, a second conveyance unit configured to convey the sheet on which the image is formed by the image forming unit, a second sensor configured to detect the sheet on which the image is formed while being conveyed by the second conveyance unit, the second sensor being used to detect an inclination of a leading edge and an inclination of a trailing edge of the sheet in the conveyance direction, a switch-back unit, which is provided downstream of the second sensor in the conveyance direction, configured to switch-back the sheet, a third conveyance unit configured to convey the sheet switched back by the switch-back unit to the first conveyance unit in a case where images are to be formed on both surfaces of the sheet, and a controller configured to control duplex printing in which images are to be formed on both surfaces of the sheet, the controller being configured to control the second sensor to detect the sheet after the image forming unit forms an image on a first surface of the sheet, control the first sensor to detect the sheet conveyed by the third conveyance unit and the first conveyance unit, and in a case where the image forming unit forms an image on a second surface of the sheet, control the orientation control unit to control the orientation of the sheet on which an image is to be formed on the second surface by the image forming unit, based on an inclination of a leading edge of the sheet that has the image formed on the first surface and is detected by the second sensor, an inclination of a trailing edge of the sheet that has the image formed on the first surface and is detected by the second sensor, and an inclination of a leading edge of the sheet that has the image formed on the first surface and is detected by the first sensor.

Further features of the present invention will become apparent from the following description of embodiments with reference to the attached drawings.

### BRIEF DESCRIPTION OF THE DRAWINGS

FIG. 1 is a general configuration diagram of an inkjet recording apparatus.

FIG. 2 is a schematic cross-sectional view of a print module.

FIG. 3 is a perspective view of the principal part of a print belt unit.

FIG. 4 is a perspective view of a registration unit and its surrounding configuration.

FIGS. 5A to 5E are schematic views of the principal part of the registration unit.

FIG. 6 is a schematic diagram illustrating a case where a front-rear surface deviation is generated.

FIG. 7 is a schematic diagram illustrating another case where a front-rear surface deviation is generated.

FIGS. 8A to 8C illustrate data indicating measurement results of deviation in perpendicularity and front-rear surface deviation.

FIG. 9 is a schematic cross-sectional view of an in-line scanner unit.

FIG. 10 is a control block diagram of the inkjet recording apparatus.

FIG. 11 is a schematic diagram illustrating a method of determining the target inclination for a sheet leading end.

FIG. 12 is a schematic diagram illustrating a method of determining the target position in a width direction of a sheet.

FIG. 13 is a flowchart illustrating an image forming operation.

### DESCRIPTION OF THE EMBODIMENTS

### (Image Forming Apparatus)

Hereinafter, an inkjet recording apparatus according to an embodiment of the present invention will be described with reference to the drawings.

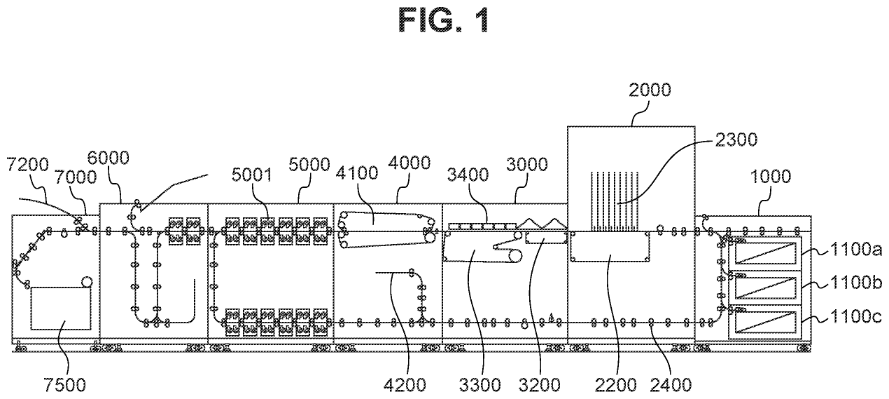

FIG. 1 is a schematic diagram illustrating an example of a schematic configuration of an inkjet recording apparatus. This inkjet recording apparatus is a cut sheet inkjet recording apparatus that forms ink images on sheets S using two types of liquid, reaction liquid and ink to manufacture recording products.

The inkjet recording apparatus according to the present embodiment includes a sheet feeding module 1000, a print module 2000, a drying module 3000, a fixing module 4000, a cooling module 5000, a reversing module 6000, and a sheet discharging and stacking module 7000. Cut sheets (hereinafter, will be referred to as the sheets S) supplied from the sheet feeding module 1000 are conveyed along a conveyance path, subjected to processing in modules, and discharged to the sheet discharging and stacking module 7000.

The sheet feeding module 1000 includes three storages 1100a to 1100c storing the sheets S arranged. The storages 1100a to 1100c are drawable from the apparatus front surface. The sheets S are fed one by one from any of the storages 1100a to 1100c by the separation belt and the conveyance roller, and conveyed to the print module 2000. The number of the storages 1100a to 1100c is not limited to three, and can be one, two, or four or more.

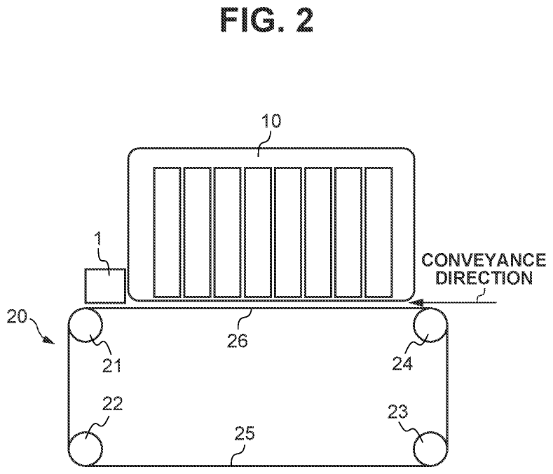

The print module 2000 includes a registration unit 2100 (not shown in FIG. 1), a print belt unit 2200, and a recording unit 2300. Each of the sheets S conveyed from the sheet feeding module 1000 is conveyed to the print belt unit 2200 after the inclination of the sheet S and the position of the sheet S in a predetermined direction (for example, a width direction of the sheet S) intersecting with the conveyance direction in which the sheet S is conveyed are corrected by the registration unit 2100. The recording unit 2300 is arranged on the conveyance path at a position facing the print belt unit 2200. The recording unit 2300 functions as an image forming unit that forms images on the conveyed sheets S. The recording unit 2300 forms images on the sheets S with ink ejected by a recording head 10 (FIG. 2) from above onto the conveyed sheets S. Each of the sheets S is conveyed while being sucked by the print belt unit 2200, ensuring the clearance between the sheet S and the recording head 10 (FIG. 2).

A plurality of recording heads 10 (FIG. 2) are arranged in the conveyance direction. In this example, the print module 2000 includes five line-type recording heads that consists of reaction liquid added to four colors, yellow (Y), magenta (M), cyan (C), and black (Bk). Each line-type recording head includes a plurality of ink ejection ports arranged in its longer side direction. The number of colors and the number of recording heads 10 (FIG. 2) are not limited to five. Examples of an inkjet method that can be employed include a method with a heater element, a method with a piezoelectric element, a method with an electrostatic element, or a method with a microelectromechanical system (MEMS) element. The ink of each color is supplied from the ink tank (not illustrated) to the recording head 10 (FIG. 2) via the ink tube. Each of the sheets S on which an image is printed by the recording unit 2300 is conveyed by the print belt unit 2200, and read by an in-line scanner unit 1 (FIG. 2) arranged in the conveyance direction downstream of the recording unit 2300. Through detection of the position deviation and the color density of the image formed on the sheet S based on the image of the sheet S read by the in-line scanner unit 1 (FIG. 2), the inkjet recording apparatus according to the present embodiment can correct a subsequent image to be printed.

The drying module 3000 is a unit that includes a decoupling unit 3200, a drying belt unit 3300, and a hot air blowing unit 3400 to decrease the liquid component contained in the ink on each of the sheets S applied by the recording unit 2300 to enhance the fixability of the sheet S and the ink. The hot air blowing unit 3400 of the drying module 3000 functions as a drying unit that dries an image on each of the sheets S. Each of the sheets S on which an image is printed by the recording unit 2300 of the print module 2000 is conveyed to the decoupling unit 3200 arranged in the drying module 3000. In the decoupling unit 3200, the sheet S can be conveyed using the pressure of air from above and the friction of a belt while being held on the belt, preventing shift of each of the sheets S on the belt. While each of the sheets S conveyed from the decoupling unit 3200 is being sucked and conveyed, the surface of the sheet S on which the ink is applied is dried by hot air applied from the hot air blowing unit 3400 arranged above the belt.

The fixing module 4000 includes a fixing belt unit 4100 including an upper belt unit and a lower belt unit. The fixing module 4000 moves the sheet S conveyed from the drying module 3000 between the upper belt unit and the lower belt unit to which heat is applied, fixing the ink solvent to the sheet S. The fixing belt unit 4100 of the fixing module 4000 functions as a fixing unit that fixes images to the sheets S.

The cooling module 5000 includes a plurality of cooling units 5001 to cool the high-temperature sheet S conveyed from the fixing module 4000. The cooling units 5001 are each configured to cool the sheet S by taking in external air into a cooling box using a fan to increase the pressure in the cooling box, and exposing the sheet S to air blown out of nozzles formed on a conveyance guide. The cooling units 5001 are arranged on both sides of the conveyance path, and can cool both surfaces of the sheet S. The cooling units 5001 of the cooling module 5000 each function as a cooling unit that exposes the sheet S to air to cool the sheet S. The cooling module 5000 also includes a conveyance path switching unit. The conveyance path of the sheet S can be switched between the conveyance path used to convey the sheet S to the reversing module 6000, and the conveyance path used to a duplex conveyance path used in duplex printing. In the duplex printing, the sheet S is conveyed to a lower conveyance path in the cooling module 5000, and further conveyed along the duplex conveyance path in the fixing module 4000, the drying module 3000, the print module 2000, and the sheet feeding module 1000. After that, the sheet S is conveyed to the registration unit 2100 and the print belt unit 2200 of the print module 2000, and an image is printed by the recording unit 2300 on the second surface of the sheet S. A duplex conveyance unit of the fixing module 4000 includes a reversing unit 4200 that reverses the surface of the sheet S.

The reversing module 6000 includes a reversing unit 6400. The reversing module 6000 can reverse the surface of the sheet S to be discharged to change the orientation of the sheet S.

The sheet discharging and stacking module 7000 includes a top tray 7200 and a stacking unit 7500, and neatly stacks the sheets S conveyed from the reversing module 6000. The top tray 7200 functions as a discharge unit to which the sheets S are to be discharged, or the stacking unit 7500 functions as the discharge unit.

### (Ink)

Each type of ink contains 0.1 to 20.0 mass % of resin component with respect to its ink total mass, water, water-soluble organic solvent, its color material, wax, and an additive agent.

### (Drying Function Unit)

The heating and drying module 3000 heats and dries the reaction liquid and the ink on the sheet S to promote the evaporation of the liquid component in the reaction liquid and the ink, preventing cockling of the sheet S.

The drying module 3000 can be any device that is capable of heating and drying, and various conventionally-known devices can be appropriately used. Desirably, a hot-air dryer or a heater is used. Any type of heater may be used, and it is desirable that the heater is appropriately selected from among known methods. Among others, desirable methods are heating using a heating wire or an infrared heater from the viewpoint of safety and energy efficiency.

### (Print Module)

FIG. 2 is a schematic cross-sectional view of the print module 2000. The print belt unit 2200 includes a print belt 25, four tension rollers 21 to 24 that support the print belt 25 in a tensioned state, and a fan (not illustrated). The belt surface of the print belt 25 that faces the recording head 10 is called an image formation surface 26 supported by the tension rollers 21 and 24 in the tensioned state. Suction holes (not illustrated) are formed in the print belt 25. The print belt 25 conveys the sheet S being sucked on the print belt 25 by the fan (not illustrated) taking in air through the suction holes. The sheet S conveyed in the conveyance direction in FIG. 2 is held on the print belt 25. While the sheet S passes through the image formation surface 26, the recording head 10 forms an image on the sheet S.

The in-line scanner unit 1 that reads the sheet S on the print belt 25 (an image formed on the sheet S) is disposed downstream of the recording head 10 in the conveyance direction in which the sheet S is conveyed. Specifically, the inkjet recording apparatus includes the in-line scanner unit 1 provided between the recording head 10 and the drying module 3000 in the conveyance direction. It can also be said that the inkjet recording apparatus include the in-line scanner unit 1 provided between the recording head 10 and the fixing module 4000 in the conveyance direction. The in-line scanner unit 1 according to the present embodiment is provided upstream of the fixing module 4000 in the conveyance direction, but the configuration is not limited to this configuration. For example, in some embodiments, the in-line scanner unit 1 reads the sheets S (images formed on the sheets S) at a position downstream of the fixing belt unit 4100 and upstream of the reversing unit 4200 in the conveyance direction.

### (Print Belt Unit)

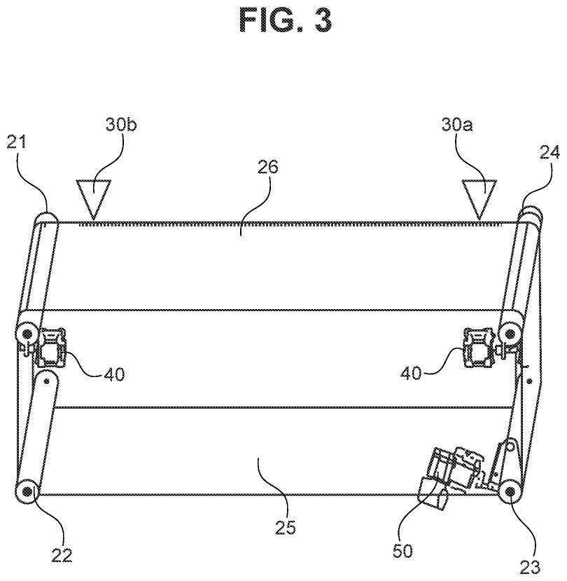

FIG. 3 is a perspective view of the principal part of the print belt unit 2200. The tension roller 21 is a drive roller that rotates the print belt 25. The tension roller 22 is a tension roller that presses the print belt 25 toward the outside of the print belt 25 from the inner surface of the print belt 25. The tension roller 24 is a driven roller to be rotationally driven by the rotation of the print belt 25.

Edge sensors 30a and 30b detect an edge portion of the print belt 25. The amount of leaning of the print belt 25 is detected based on the positions of the edge portion detected by the edge sensors 30a and 30b. One end portion of the tension roller 23 is swung by a motor 50 so as to correct a leaning movement of the print belt 25 in a width direction (direction of the longitudinal side of the recording head 10) orthogonal to the conveyance direction in which the sheet S is conveyed. The tension roller 23 and the motor 50 function as a steering roller for correcting the leaning movement of the print belt 25. The direction of the longitudinal side of the recording head 10 is orthogonal to the conveyance direction (predetermined conveyance direction) in which the print belt unit 2200 conveys the sheet S without being skewed.

The tension roller 24 is moved by a motor 40 in axial line directions (thrust direction) of the tension roller 24 based on the edge sensor 30a in such a manner that brings the position of the edge portion detected by the edge sensor 30a to the target position. Similarly, the tension roller 21 is moved by the motor 40 in axial line directions (thrust direction) of the tension roller 21 based on the edge sensor 30b in such a manner that brings the position of the edge portion detected by the edge sensor 30b to the target position.

The amount of movement in a thrust direction is determined in such a manner that makes the difference between repeatedly-detected edge positions and the edge position corresponding to one previous rotation of the print belt 25 smaller. The position control of the print belt 25 by movement in a thrust direction is constantly performed while the print belt 25 is rotating.

### (Registration Unit 2100)

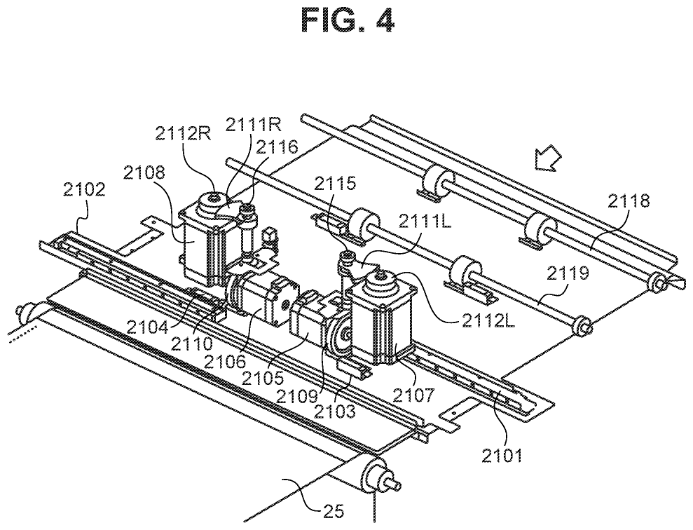

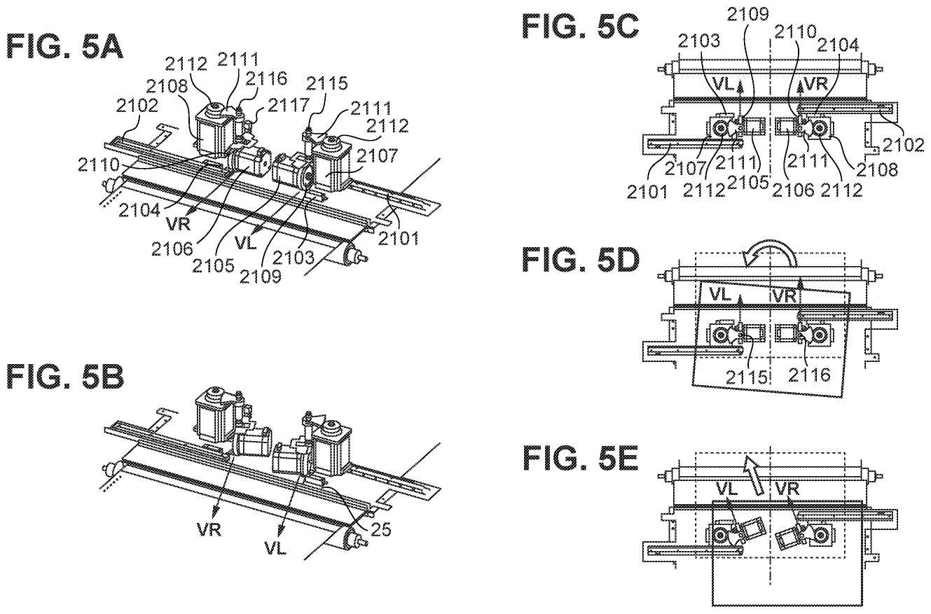

FIG. 4 is a perspective view of the registration unit 2100 and its surrounding configuration. FIGS. 5A to 5E are schematic views of the principal part of the registration unit 2100. The registration unit 2100 includes image sensors 2101 and 2102, registration sensors 2103 and 2104, motors 2105 and 2106, steering motors 2107 and 2108, and registration rollers 2109 and 2110. A conveyance roller pair 2119 is arranged in the conveyance direction upstream of the sheets S of the registration unit 2100. A conveyance roller pair 2118 is arranged in the conveyance direction upstream of the sheets S of the conveyance roller pair 2119. The conveyance roller pairs 2118 and 2119 convey the sheets S to the registration unit 2100. The conveyance roller pair 2119 functions as a first conveyance unit. The configuration of the first conveyance unit is not limited to the configuration of the conveyance roller pair 2119. The first conveyance unit can be a belt member that conveys sheets while holding the sheet, for example.

The registration rollers 2109 and 2110 of the registration unit 2100 receive each of the sheets S conveyed from the conveyance roller pairs 2118 and 2119. The registration rollers 2109 and 2110 are rubber rollers made of polyurethane. The registration roller 2109 is rotationally driven by the motor 2105. The registration roller 2109 forms a nip portion for nipping the sheet S, by pressing a driven roller (not illustrated) facing the registration roller 2109. The registration roller 2110 is rotationally driven by the motor 2106. The registration roller 2110 forms a nip portion for nipping the sheet S, by pressing a driven roller (not illustrated) facing the registration roller 2110. The registration rollers 2109 and 2110 being driven by the motors 2105 and 2106 convey the sheet S toward the print belt unit 2200.

The registration sensors 2103 and 2104 serve as a first sensor to be used to detect the inclination of the leading edge of the sheet S in the conveyance direction. The registration sensors 2103 and 2104 detect timings at which the leading edge (and the trailing end side) of the sheet S passes through the detection positions. The detection position of the registration sensor 2103 and the detection position of the registration sensor 2104 differ in a width direction orthogonal to the conveyance direction of the sheet S. Based on the difference between the timings at which the registration sensor 2103 detects the leading edge of the sheet S and at which the registration sensor 2104 detects the leading edge of the sheet S, the inclination (skew amount) of the leading edge of the sheet S with respect to a predetermined direction (for example, a direction orthogonal to the conveyance direction) is obtained. The registration rollers 2109 and 2110 are respectively driven by different drive motors (motors 2105 and 2106). As illustrated in FIGS. 5A to 5E, the registration unit 2100 can correct the skew of the sheets S by adjusting the speed difference between a conveyance speed VL of the registration roller 2109 and a conveyance speed VR of the registration roller 2110.

The registration unit 2100 also changes the angle of the rotational shaft of the registration roller 2109 with respect to a direction orthogonal to the conveyance direction of the sheets S. The rotational shaft of the registration roller 2109 is supported by a steering shaft 2115. An axial line direction of the steering shaft 2115 is a direction vertical to the surfaces of the sheets S conveyed by the registration roller 2109. The steering shaft 2115 is driven by the steering motor 2107 via a drive input gear 2111L and a motor gear 2112L to rotate around an axial line direction. This rotation swings the rotational shaft of the registration roller 2109 around the rotational axis of the steering shaft 2115, whereby the registration roller 2109 controls the skew direction of the sheets S. The skew direction refers to a direction (of skew) in which the sheet S is obliquely conveyed with respect to the predetermined conveyance direction.

Similarly, the registration unit 2100 changes the angle of the rotational shaft of the registration roller 2110 in a direction orthogonal to the conveyance direction of the sheets S. The rotational shaft of the registration roller 2110 is supported by a steering shaft 2116. An axial line direction of the steering shaft 2116 is a direction vertical to the surfaces of the sheets S conveyed by the registration roller 2110. The steering shaft 2116 is driven by the steering motor 2108 via a drive input gear 2111R and a motor gear 2112R to rotate around an axial line direction. This rotation swings the rotational shaft of the registration roller 2110 around the rotational axis of the steering shaft 2116, whereby the registration roller 2110 controls the skew direction of the sheets S.

FIG. 5A illustrates a direction in which the registration rollers 2109 and 2110 apply conveyance forces to the sheets S with angles of the rotational shafts of the registration rollers 2109 and 2110 being parallel to an orthogonal direction (width direction) orthogonal to the conveyance direction of the sheets S. Rotation of the steering shafts 2115 and 2116 changes the direction in which the registration rollers 2109 and 2110 apply conveyance forces to the sheets S as illustrated in FIG. 5B.

The description will return to FIG. 4. The image sensor 2101 (or 2102) is a sensor used to detect the position of each of the sheets S in a width direction of the sheet S. The image sensor 2101 detects one edge portion of the sheet S, and the image sensor 2102 detects the other edge portion of the sheet S. The registration unit 2100 detects the position of the sheet S in the width direction from the detection result of the edge portions of the sheet S, and the angles of the rotational shafts of the registration rollers 2109 and 2110 are adjusted in such a manner that brings the position in the width direction of the sheet S to the target position (width direction). The target position (width direction) is assumed to be a center position in the width direction of the print belt 25, for example.

FIG. 5C is a schematic diagram illustrating a state before a sheet S is conveyed to the registration rollers 2109 and 2110. As illustrated in FIG. 5D, the registration unit 2100 controls the speed difference between the conveyance speeds VL and VR of the registration rollers 2109 and 2110 based on the inclination (skew amount) of the leading edge of a conveyed sheet S detected by the registration sensors 2103 and 2104. For simple description, the orientation of the sheet S is controlled in such a manner that rotates the sheet S to make the leading edge of the sheet S parallel to the width direction. Furthermore, as illustrated in FIG. 5E, the registration unit 2100 controls the angles of the rotational shafts of the registration rollers 2109 and 2110 based on the positions of edge portions of the sheet S that are detected by the image sensors 2101 and 2102. With this configuration, even if the conveyance position of the sheet S in the width direction is at a position closer to the registration roller 2110 than the target position (width direction), the sheet S is obliquely conveyed and the print belt 25 holds the sheet S in a state in which the sheet S has reached the target position (width direction).

### (Front-Rear Surface Deviation)

When images are to be formed on both surfaces of a sheet S in the inkjet recording apparatus, the sheet S switched back by the reversing unit 4200 is conveyed by a conveyance roller pair 2400 (FIG. 1) to the conveyance roller pair 2119 (FIG. 4). The inkjet recording apparatus switches back the sheet S of which the first surface (front surface) has an image formed on it using the reversing unit 4200, whereby the surfaces of the sheet S with respect to the conveyance direction are reversed. The sheet S from the reversing unit 4200 is borne again on the print belt 25 by the conveyance roller pair 2400 (FIG. 1) and the conveyance roller pair 2119 (FIG. 4), and an image is formed by the recording head 10. At this time, the sheet S is borne on the print belt 25 with the second surface (rear surface) of the sheet S oriented upward, and the image is formed by the recording head 10 on the second surface (rear surface) of the sheet S. In the configuration of switching-back the sheet S in duplex printing, the leading edge serving as the reference side of the first surface and the leading edge serving as the reference side of the second surface (trailing end side of the sheet S of which the first surface has the image formed on it) become reversed. In duplex printing, the leading edge in the conveyance direction of the sheet S before being switched back by the reversing unit 4200 becomes the trailing end side in the conveyance direction of the sheet S through the switch-back performed by the reversing unit 4200. On the other hand, in duplex printing, the trailing end side in the conveyance direction of the sheet S before being switched back by the reversing unit 4200 becomes the leading edge in the conveyance direction of the sheet S through the switch-back performed by the reversing unit 4200. The conveyance roller pair 2400 (FIG. 1) function as a third conveyance unit. The configuration of the third conveyance unit is not limited to the configuration of the conveyance roller pair 2400. The third conveyance unit can be a belt member that conveys a sheet while holding the sheet, for example.

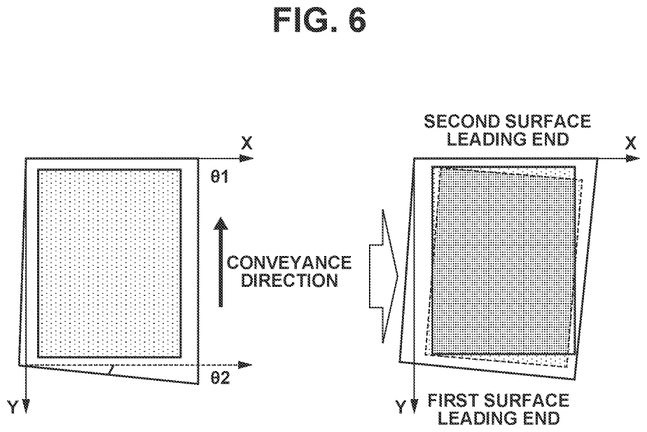

Thus, in the configuration in which the orientation of the sheet S is controlled in such a manner that makes the leading edge of the sheet S parallel to the width direction orthogonal to the conveyance direction, if the leading edge and the trailing end side of the sheet S are not parallel, the inclination of the reference side of the first surface and the inclination of the reference side of the second surface are different as illustrated in FIG. 6. The deviation corresponding to θ2-θ1 is accordingly generated between the image formed on the first surface of the sheet S and the image formed on the second surface of the sheet S.

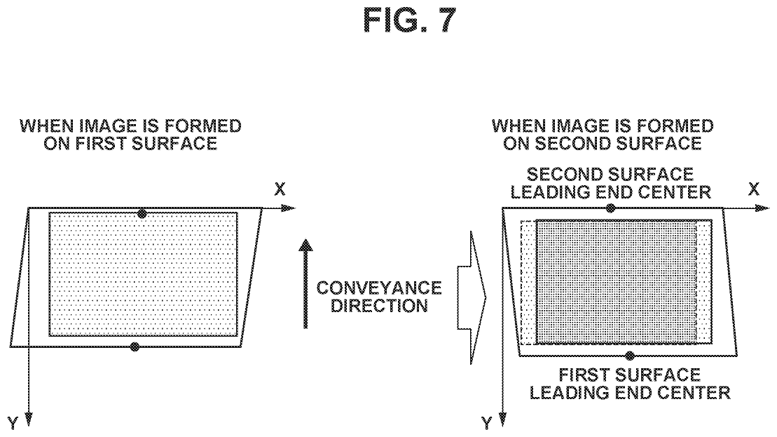

The conveyance position (passing position) of the sheet S in the width direction of the sheet S is controlled in such a manner that makes the center position of the leading edge of the sheet S when an image is formed on the second surface coincide with the center position of the leading edge of the sheet S when an image is formed on the first surface. In this configuration, a deviation could be generated in the width direction of the sheet S irrespective of the angle of the leading edge of the sheet S with respect to the conveyance direction. As illustrated in FIG. 7, with both end sides in the width direction orthogonal to the conveyance direction of the sheet S inclined with respect to the conveyance direction, the conveyance position in the width direction of the sheet S is wrongly corrected. In this case, the deviation corresponding to the difference in center position between the leading edge and the trailing end side is generated between the position of an image formed on the first surface and the position of an image formed on the second surface.

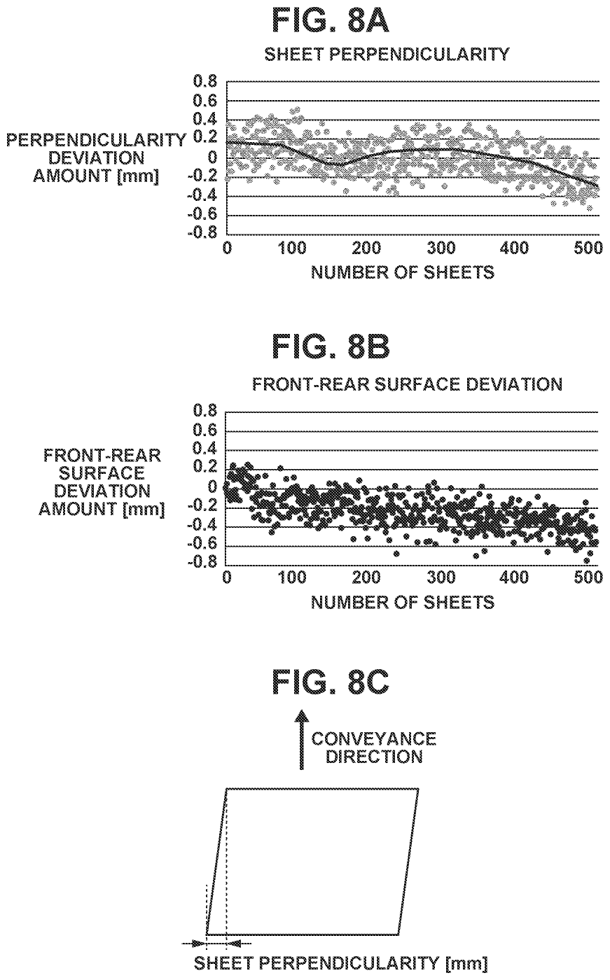

FIGS. 8A to 8C illustrate data indicating results of an experiment carried out by the inventors on deviations in the width direction of the sheet S that is attributed to deviations in center position between the leading edge and the trailing end side (deviation in perpendicularity of the sheet S). FIG. 8A illustrates a result obtained by measuring deviations in perpendicularities of 500 sheets S one by one. The X-axis (horizontal axis) indicates the number of sheets fed, and the Y-axis (vertical axis) indicates amounts of perpendicularity deviation of the sheets S. FIG. 8B illustrates a result obtained by measuring deviations (hereinafter, will be referred to as front-rear surface deviations) in image formation position between images on the first surfaces and images on the second surfaces of the 500 sheets S. The X-axis (horizontal axis) indicates the number of sheets fed, and the Y-axis (vertical axis) indicates amounts of front-rear surface deviation. As illustrated in FIG. 8C, the amount of perpendicularity deviation of a sheet S is defined as the distance between the corner of the trailing end side of the sheet S and a virtual straight line orthogonal to the leading edge of the sheet S, the virtual straight line being drawn from a corner of the leading edge of the sheet S.

The trend of the perpendicularity deviation of the sheets S illustrated in FIG. 8A is similar to the trend of the front-rear surface deviation illustrated in FIG. 8B. This suggests that a front-rear surface deviation of an image formed on a sheet S is generated due to a difference in shape between the leading end and the trailing end of the sheet S. It is known that such a shape difference (deviation in parallelism or perpendicularity) between the leading end and the trailing end of a sheet S is generated due to a deviation generated during sheet cutting and to a sheet shrink attributed to an environmental fluctuation. It is also known that variations also occur while images are being formed on a plurality of sheets S.

Thus, the inkjet recording apparatus described in the present embodiment acquires the shape of a sheet S of which the first surface has an image formed on it, and controls the inclination (skew amount) of the leading edge of the sheet S when an image is formed on the second surface of the sheet S, based on the inclinations of the leading edge and the trailing end side of the first surface of the sheet S.

In forming an image on the second surface of the sheet S, the inkjet recording apparatus controls the orientation of the sheet S in such a manner that makes the inclination (skew amount) of the leading edge of the sheet S after a switch-back the target inclination for the second surface.

Even if the inclination (skew amount) of the leading edge of a sheet S when an image is formed on the first surface is corrected so as to be the target inclination for the first surface, a correction error could remain in the inclination (skew amount) of the leading edge of the sheet S. Thus, the inkjet recording apparatus described in the present embodiment determines the target inclination for the leading edge for the second surface using the inclination of the trailing end side of the sheet S of which the first surface has an image formed on it, as well as the inclination (skew amount) of the leading edge of the sheet S of which the first surface has an image formed on it.

The inkjet recording apparatus described in the present embodiment also controls the position (reference position) in the width direction of the sheet S at which the sheet S will pass when an image is formed on the second surface of the sheet S, based on the shape of the sheet S of which the first surface has an image formed on it. After the image is formed on the first surface, the center position of the leading edge of the sheet S and the center position of the trailing end side of the sheet S are acquired based on the shape of the sheet S. Subsequently, the inkjet recording apparatus shifts the target position for the center position of the leading edge of the second surface of the sheet S in the width direction of the sheet S by an amount corresponding to the difference between the center position of the leading edge of the first surface of the sheet S and the center position of the trailing end side of the first surface of the sheet S.

In the conveyance direction of the sheet S, margin lengths at the leading end and the trailing end are set to predetermined values. If the leading edge and the trailing end side in the conveyance direction of the sheet S are not parallel, there is, however, a possibility that image formation positions of an image on the first surface and an image on the second surface does not coincide in the conveyance direction. In view of the foregoing, the inkjet recording apparatus according to the present embodiment detects the length in the conveyance direction of the sheet S from the coordinates of the four corners of the sheet S, compares the detected length with a standard length (so-called length) in the conveyance direction that corresponds to its sheet size, and adjusts the margin length at the leading end of an image on the second surface. Specifically, the detected length longer than the reference length results in a long margin length at the trailing end of an image on the first surface, so that the margin length at the leading end of an image on the second surface is made longer than a predetermined value by an amount corresponding to the difference between the detected length and the reference length. On the other hand, the detected length shorter than the reference length results in a short margin length at the trailing end of the image on the first surface, so that the margin length at the leading end of an image on the second surface is made shorter than a predetermined value by an amount corresponding to the difference between the detected length and the reference length.

To detect the shape, the four corners, and the length of the sheet S in the conveyance direction of the sheet S, the inkjet recording apparatus includes the in-line scanner unit 1 provided downstream of the recording head 10 (FIG. 2) in the conveyance direction. The in-line scanner unit 1 can read the sheet S immediately after an image is formed on the first surface, at a reading position in the conveyance direction downstream of a recording position at which the recording head 10 (FIG. 2) ejects ink. The in-line scanner unit 1 is a second sensor that detects the sheet S while the sheet S is conveyed by the print belt unit 2200. The print belt unit 2200 corresponds to a second conveyance unit that conveys the sheet S on which an image is formed. Based on a read image of the sheet S read by the in-line scanner unit 1, the inkjet recording apparatus acquires the shape, the four corners, and the length of the sheet S in the conveyance direction of the sheet S, and controls the conveyance of the sheet S in forming an image on the second surface.

### (In-Line Scanner Unit)

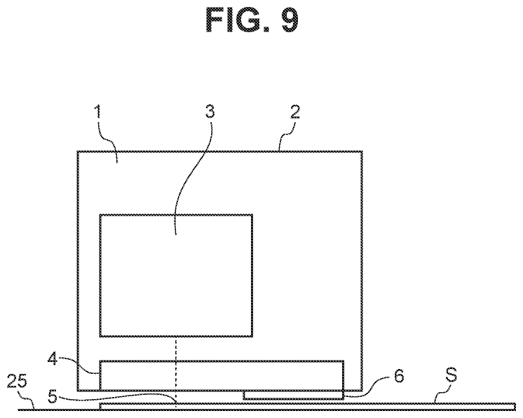

FIG. 9 is a schematic cross-sectional view of the in-line scanner unit 1 provided in the conveyance direction downstream of the recording head 10 (FIG. 2). The in-line scanner unit 1 reads the shape of a sheet S held on the print belt 25 and an image (registration mark) on the sheet S. The in-line scanner unit 1 includes a housing 2, a line sensor 3 accommodated in the housing 2, a reading glass 4, and a reference plate 6. By emitting light from a light source (not illustrated) and receiving reflected light from the sheet S via the reading glass 4, the line sensor 3 generates a read image of the sheet S.

The line sensor 3 is a contact image sensor (CIS) or a charge-coupled device (CCD) sensor. In the in-line scanner unit 1, the line sensor 3 is movable in such a manner that the line sensor 3 receives reflected light from the reference plate 6. The in-line scanner unit 1 performs shading correction for controlling the output value of each pixel from the line sensor 3 to reach a target value, based on the reflected light from the reference plate 6 received by the line sensor 3.

### (System Configuration)

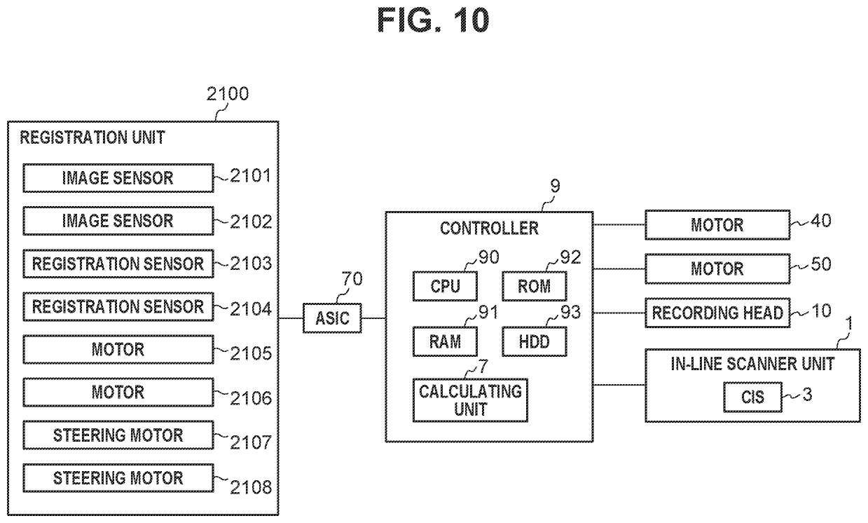

FIG. 10 is a control block diagram of the inkjet recording apparatus. Hereinafter, conveyance control of the conveyance of the sheets S under the control of the registration unit 2100 will be described with reference to the control block diagram illustrated in FIG. 10.

A controller 9 includes a central processing unit (CPU) 90, and generally controls the inkjet recording apparatus. A random access memory (RAM) 91 is a system work memory to be used by the CPU 90 for processing. A read-only memory (ROM) 92 stores control programs for controlling various types of processing to be performed in the inkjet recording apparatus. A hard disk drive (HDD) 93 stores, in association with each sheet, a read image of the sheet S read by the line sensor 3 of the in-line scanner unit 1, a target inclination for the second surface calculated by a calculating unit 7, a correction value of the target inclination for the second surface, and a margin length of the second surface.

The calculating unit 7 determines the coordinates of the four corners of the sheet S from the read image on the first surface of the sheet S stored in the HDD 93, and finds the inclinations of the leading edge and the trailing end side of the first surface based on the coordinates. The inclination of the leading edge of the first surface is an inclination of the leading edge of a sheet S with respect to a predetermined conveyance direction, the inclination being acquired at the reading position of the in-line scanner unit 1 after an image is formed on the first surface. The inclination of the trailing end side of the first surface is an inclination of the trailing end side of a sheet S with respect to a predetermined conveyance direction, the inclination being acquired at the reading position of the in-line scanner unit 1 after an image is formed on the first surface. The calculating unit 7 calculates the target inclination for the second surface based on the inclinations of the leading edge and the trailing end side of the first surface. The calculating unit 7 functions as a first generation unit that generates the target inclination for the second surface based on data corresponding to the inclination of the leading edge and data corresponding to the inclination of the trailing end side of the sheet S of which the first surface has an image formed on it before the sheet S is switched back. Furthermore, the calculating unit 7 determines the coordinates of the center positions of the leading edge and the trailing end side of the first surface based on the coordinate of the four corners of the sheet S, and calculates the correction value for the target inclination for the second surface (width direction) based on the coordinates of the center positions of the leading edge and the trailing end side of the first surface. The calculating unit 7 functions as a second generation unit that generates the target position for the second surface (width direction) based on data corresponding to the position at the leading end and data corresponding to the position at the trailing end in the width direction of the sheet S of which the first surface has an image formed on it before the sheet S is switched back. Furthermore, the calculating unit 7 calculates the length in the conveyance direction of the sheet S based on the coordinates of the center positions of the leading edge and the trailing end side of the first surface to determine the margin length at the leading end of the second surface of the sheet S.

An application specific integrated circuit (ASIC) 70 controls the registration unit 2100. The registration unit 2100 (and the ASIC 70) function(s) as an orientation control unit that controls the orientation of the sheet S being conveyed. The registration unit 2100 (and the ASIC 70) has (have) a function of controlling the inclination (skew amount) of the leading edge of the sheet S, for example. The registration unit 2100 (and the ASIC 70) also has (have) a function of controlling the position in the width direction of a sheet S, for example. The following description will be given assuming that the ASIC 70 controls the registration unit 2100, but the CPU 90 of the controller 9 controls the registration unit 2100 in place of the ASIC 70.

To form an image on the first surface of the sheet S, the ASIC 70 detects the end portions in the width direction of the sheet S using the image sensors 2101 and 2102, and detects the inclination (skew amount) of the leading edge in the conveyance direction of the sheet S using the registration sensors 2103 and 2104. Subsequently, the ASIC 70 determines the speed difference between the registration rollers 2109 and 2110 based on the detection results of the registration sensors 2103 and 2104 in such a manner that brings the inclination (skew amount) of the leading edge of the sheet S to a target inclination for the first surface. The target inclination for the first surface is a predetermined inclination at which the leading edge of the sheet S is parallel to the width direction of the sheet S. The relationship between the speed difference between the two registration rollers 2109 and 2110 for controlling the inclination to bring the inclination to the target inclination, and the inclination (detected inclination) of the leading edge is prestored in the ROM 92 as data. The ASIC 70 determines the speed difference (speed difference on the first surface) between the two registration rollers 2109 and 2110 in forming an image on the first surface of the sheet S, based on the inclination (detected inclination) of the leading edge from the data stored in the ROM 92. The ASIC 70 then controls the rotational speeds of the motors 2105 and 2106 based on the above-described speed difference on the first surface.

In addition, the ASIC 70 determines the inclinations of the rotational shafts of the registration rollers 2109 and 2110 based on the detection results of the image sensors 2101 and 2102 in such a manner that brings the center position of the leading edge of the sheet S to a target position. The target position for the first surface is predetermined and stored in the ROM 92. The ASIC 70 controls the amounts of rotation of the steering motors 2107 and 2108 in such a manner that brings the center position to the target position stored in the ROM 92.

Next, in duplex printing to form images on both surfaces (the front surface and the rear surface) of the sheet S, after the recording head 10 forms an image on the first surface of the sheet S (front surface), the sheet S is read by the in-line scanner unit 1 provided downstream of the recording head 10 in the conveyance direction.

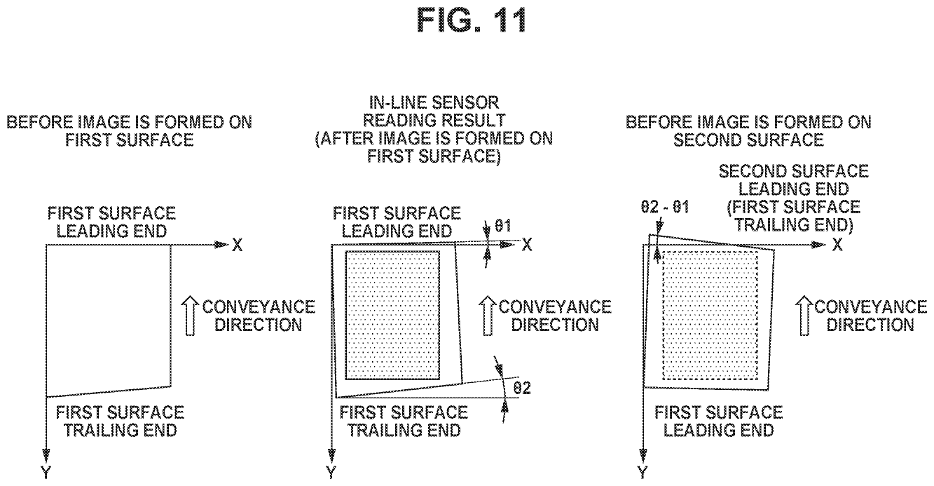

To reduce the front-rear surface deviation attributed to the deviation in parallelism between the leading edge and the trailing end side of the sheet S, the calculating unit 7 determines the target inclination for the leading edge for the second surface before an image is formed on the second surface (rear surface) of the sheet S. A method of determining the target inclination for the second surface will now be described with reference to FIG. 11.

After an image is formed on the first surface, the calculating unit 7 detects positions (X1, Y1) to (X4, Y4) of the four corners of the sheet S of which the first surface has the image formed on it, based on a read image of the sheet S read by the in-line scanner unit 1. The calculating unit 7 calculates an angle θ1 of the leading edge of the sheet S and an angle θ2 of the trailing end side of the sheet S using the following equations:

$$θ 1 = Arc tan ( ( Y 2 - Y 1 ) / ( X 2 - X 1 ) ) , and$$

$$θ2 = arctan ( ( Y 4 - Y 3 ) / ( X 4 - X 3 ) )$$

Then, the calculating unit 7 determines the deviation in parallelism between the leading edge and the trailing end side of the sheet S, as the angle difference θ2−θ1 between the leading edge and the trailing end side of the sheet S.

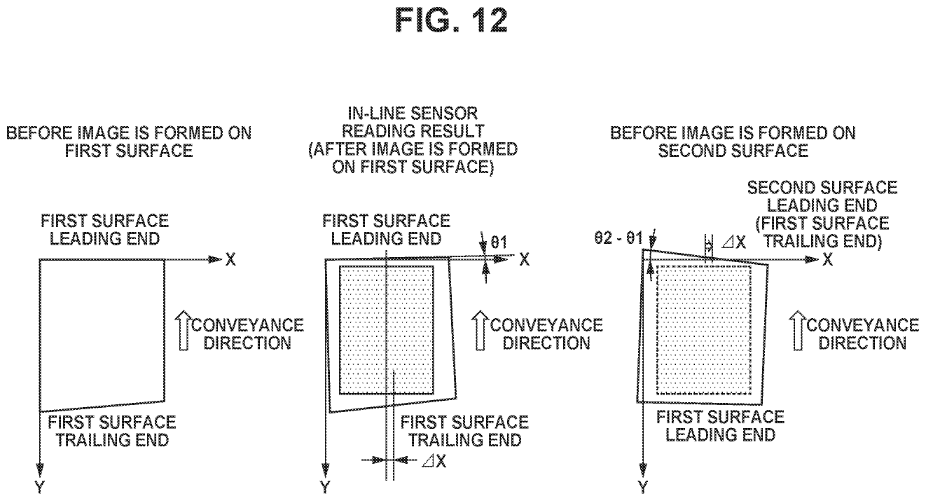

Furthermore, to reduce the front-rear surface deviation attributed to the deviation in perpendicularity of the sheet S, the calculating unit 7 determines the target position in the width direction for the second surface before an image is formed on the second surface of the sheet S. A method of determining the correction value for the target position for the second surface will now be described with reference to FIG. 12.

The calculating unit 7 calculates a center position Xlead of the leading edge of the sheet S as Xlead=X2−X1, and calculates a center position Xrear of the trailing end side of the sheet S as Xrear=X4−X3. The calculating unit 7 then calculates a correction value ΔX for a target position for the second surface as ΔX=(X4−X3)−(X2−X1).

Next, the sheet S read by the in-line scanner unit 1 is conveyed to the reversing unit 4200. In the reversing unit 4200, after the conveyance of the sheet S is stopped, a roller (not illustrated) of the reversing unit 4200 rotates reversely, switching-back the sheet S. The sheet S switched back in the reversing unit 4200 is conveyed again to the registration unit 2100 via a plurality of conveyance rollers including the conveyance roller pairs 2118, 2119, and 2400 with the second surface oriented upward.

To form an image on the second surface of the sheet S, the ASIC 70 detects the end portions in the width direction of the sheet S using the image sensors 2101 and 2102, and detects the inclination (skew amount) of the leading edge in the conveyance direction of the sheet S using the registration sensors 2103 and 2104. The ASIC 70 then determines the speed difference between the registration rollers 2109 and 2110 based on the detection results of the registration sensors 2103 and 2104 in such a manner that brings the inclination (skew amount) of the leading edge of the sheet S to the target inclination (target skew amount) of the leading edge for the second surface. The speed difference for controlling the inclination (skew amount) of the leading edge of the second surface is also determined with reference to the data stored in the ROM 92. The ASIC 70 determines the speed difference (speed difference on the second surface) between the two registration rollers 2109 and 2110 in forming an image on the second surface of the sheet S, based on the inclination (detected inclination) of the leading edge from the data stored in the ROM 92. The ASIC 70 then controls the rotational speeds of the motors 2105 and 2106 based on the above-described speed difference between the two registration rollers 2109 and 2110 on the second surface.

In addition, the ASIC 70 determines the inclinations of the rotational shafts of the registration rollers 2109 and 2110 based on the detection results of the image sensors 2101 and 2102 in such a manner that beings the center position of the leading edge of the sheet S to a target position for the second surface. The ASIC 70 determines the target position for the second surface by adding the correction value ΔX to the target position for the first surface. The ASIC 70 controls the amounts of rotation of the steering motors 2107 and 2108 in such a manner that brings the center position to the target position for the second surface.

As described above, the control of the conveyance of a sheet S by the registration unit 2100 allows accurate reduction of the front-rear surface deviation between an image on the first surface of the sheet S and an image on the second surface of the sheet S.

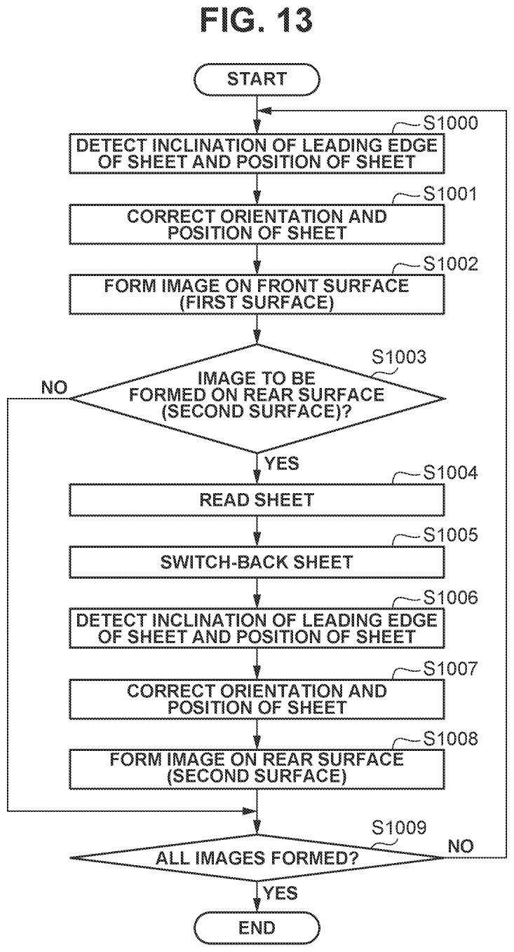

An image forming operation in which the inkjet recording apparatus functioning as an image forming apparatus forms an image on a sheet will now be described with reference to a flowchart illustrated in FIG. 13. This image forming operation is performed by the CPU 90 of the controller 9 loading a control program stored in the ROM 92 onto the RAM 91. The image forming operation illustrated in the flowchart in FIG. 13 is performed by an image formation job (image data) being transferred from an external device (server or personal computer).

In step S1000, the CPU 90 first feeds a sheet S using the sheet feeding module 1000, and causes the registration unit 2100 to detect the inclination and the position of the leading edge of the sheet S. In step S1001, the CPU 90 corrects the orientation (inclination) and the position of the sheet S. After that, if the sheet S is conveyed to the print belt unit 2200, in step S1002, the CPU 90 causes the recording unit 2300 to form an image on the first surface of the sheet S. In step S1003, the CPU 90 determines whether an image is to be formed on the rear surface (second surface) of the sheet S, based on information indicated by image data. If an image is to be formed on the rear surface (second surface) of the sheet S (YES in step S1003), the processing proceeds to step S1004. In step S1004, the CPU 90 subsequently causes the in-line scanner unit 1 to read the sheet S, and acquires an angle difference θ2−θ1 calculated by the calculating unit 7, and a correction value ΔX.

The sheet S is conveyed through the drying module 3000 and the fixing module 4000 to the cooling module 5000. When it is determined in step S1003 that an image is to be formed on the rear surface of the sheet S (YES in step S1003), the CPU 90 causes the conveyance path switching unit of the cooling module 5000 to convey the sheet S to the reversing module 6000. In step S1005, the CPU 90 conveys the sheet S to the reversing unit 4200 and switches back the sheet S. The sheet S switched back in the reversing unit 4200 is conveyed via the conveyance roller pair 2400 and the sheet feeding module 1000 to the print module 2000.

On the other hand, in step S1003, if it is determined that an image is not to be formed on the rear surface of the sheet S (NO in step S1003), the processing proceeds to step S1009. In step S1009, the CPU 90 determines whether all images included in the image data are formed. In step S1009, if it is determined in step S1009 that all images are formed (YES in step S1009), the CPU 90 ends the processing. If it is determined that all images are not formed (NO in step S1009), the CPU 90 returns the processing to step S1000, and starts image formation on the next sheet. The sheet S on which an image is formed is conveyed through the reversing module 6000 to the sheet discharging and stacking module 7000.

When an image is to be formed on the rear surface (second surface) of the sheet S, the sheet S conveyed by the conveyance roller pair 2400 reaches the print module 2000. In step S1006, the CPU 90 causes the registration unit 2100 to detect the inclination and the position of the leading edge of the sheet S. In step S1007, the CPU 90 corrects the orientation (inclination) and the position of the sheet S. In step S1007, the CPU 90 causes the registration unit 2100 to correct the orientation (inclination) of the sheet S based on the angle difference acquired in step S1006 and the inclination of the leading edge acquired in step S1004. In step S1007, the CPU 90 also causes the registration unit 2100 to correct the position of the sheet S based on the position of the sheet S acquired in step S1006 and the correction value ΔX acquired in step S1004.

After that, when the sheet S is conveyed to the print belt unit 2200, in step S1008, the CPU 90 causes the recording unit 2300 to form an image on the second surface of the sheet S. In step S1009, the CPU 90 determines whether all images included in the image data are formed. When it is determined in step S1009 that all images are not formed (NO in step S1009), the CPU 90 returns the processing to step S1000, and starts image formation on the next sheet. The sheet S on which an image is formed is conveyed through the reversing module 6000 to the sheet discharging and stacking module 7000.

The above-described image forming operation allows reduction of the deviation in formation position between an image on the front surface (first surface) of the sheet S and an image on the rear surface (second surface) of the sheet S.

To reduce a front-rear surface deviation, the calculating unit 7 according to the present embodiment generates both the target inclination and the target position for the second surface using a read image of the sheet S read by the in-line scanner unit 1. The calculating unit 7 can generate the target inclination for the second surface using a read image of the sheet S read by the in-line scanner unit 1 without making the target position for the second surface variable. This configuration also allows reduction of a front-rear surface deviation attributed to a parallelism deviation, providing a reduced deviation in image formation position compared with a configuration in which the target inclination for the second surface is not made variable. In addition, the calculating unit 7 can generate the target position for the second surface using a read image of the sheet S read by the in-line scanner unit 1, without making the target inclination for the second surface variable. This configuration allows reduction of a front-rear surface deviation attributed to a perpendicularity deviation, providing a reduced deviation in image formation position compared with a configuration in which the target position for the second surface is not made variable.

The method of reducing a front-rear surface deviation of images in the inkjet recording apparatus has been described above, but a recording method is not limited to the inkjet method as long as an image forming apparatus can form an image on the sheet S. For example, the image forming apparatus can be an electrophotographic printer including a photosensitive member, a charging device that charges the photosensitive member, an exposure device that exposes the photosensitive member to form an electrostatic latent image on the photosensitive member, and a developing device that develops the electrostatic latent image on the photosensitive member using toner. The charging device, the exposure device, and the developing device are called an image forming station. The image forming station forms an image by transferring an image to the sheet S conveyed to a transfer nip in the direction in which the sheet S is conveyed. The electrophotographic printer further includes a fixing device that fixes the image to the sheet S downstream of the transfer nip in the conveyance direction in which the sheet S is conveyed, and a reversing unit that switches back the sheet S further downstream of the fixing device in the conveyance direction.

The electrophotographic printer can be used as long as the electrophotographic printer has a configuration including the registration unit 2100 in the conveyance direction of the sheet S upstream of the transfer nip at which an image is transferred to the sheet S, and including the in-line scanner unit 1 in the conveyance direction of the sheet S downstream of the transfer nip. For example, the in-line scanner unit 1 can be arranged in the printer so as to read the sheet S at a position between the transfer nip and the fixing device in the conveyance direction. Besides, for example, the in-line scanner unit 1 can be arranged so as to read the sheet S at a position between the fixing device and the reversing unit in the conveyance direction. The fixing device functions as a fixing unit as with the fixing module 4000 (fixing belt unit 4100).

While the present invention has been described with reference to embodiments, it is to be understood that the invention is not limited to the disclosed embodiments. The scope of the following claims is to be accorded the broadest interpretation so as to encompass all such modifications and equivalent structures and functions and is limited by the appended claims.

This application claims the benefit of Japanese Patent Application No. 2023-088267, filed May 29, 2023, which is hereby incorporated by reference herein in its entirety.

What is claimed is:

1. An image forming apparatus that forms images on both surfaces of a sheet, the image forming apparatus comprising:
a first conveyance unit configured to convey a sheet;
an orientation control unit configured to control an orientation of the sheet conveyed by the first conveyance unit;
an image forming unit configured to form an image on the sheet of which the orientation is controlled by the orientation control unit;
a first sensor configured to detect the sheet while the sheet is conveyed by the first conveyance unit, the first sensor being used to detect an inclination of a leading edge of the sheet in a conveyance direction in which the sheet is conveyed;
a second conveyance unit configured to convey the sheet on which the image is formed by the image forming unit;
a second sensor configured to detect the sheet on which the image is formed while being conveyed by the second conveyance unit, the second sensor being used to detect an inclination of a leading edge and an inclination of a trailing edge of the sheet in the conveyance direction;
a switch-back unit, which is provided downstream of the second sensor in the conveyance direction, configured to switch-back the sheet;
a third conveyance unit configured to convey the sheet switched back by the switch-back unit to the first conveyance unit in a case where images are to be formed on both surfaces of the sheet; and
a controller configured to control duplex printing in which images are to be formed on both surfaces of the sheet, the controller being configured to:
control the second sensor to detect the sheet after the image forming unit forms an image on a first surface of the sheet;
control the first sensor to detect the sheet conveyed by the third conveyance unit and the first conveyance unit; and
in a case where the image forming unit forms an image on a second surface of the sheet, control the orientation control unit to control the orientation of the sheet on which an image is to be formed on the second surface by the image forming unit, based on an inclination of a leading edge of the sheet that has the image formed on the first surface and is detected by the second sensor, an inclination of a trailing edge of the sheet that has the image formed on the first surface and is detected by the second sensor, and an inclination of a leading edge of the sheet that has the image formed on the first surface and is detected by the first sensor.

2. The image forming apparatus according to claim 1, wherein the image forming unit includes a recording head configured to form an image by ejecting ink to the sheet.

3. The image forming apparatus according to claim 1, wherein the image forming unit includes a photosensitive member, a charging device configured to charge the photosensitive member, an exposure device configured to expose the photosensitive member charged by the charging device, to form an electrostatic latent image on the photosensitive member, and a developing device configured to develop the electrostatic latent image on the photosensitive member using toner.

4. The image forming apparatus according to claim 1, wherein the controller controls the orientation control unit to control the orientation of the sheet on which an image is to be formed on the second surface by the image forming unit, based on a difference between an inclination of a leading edge of the sheet that has the image formed on the first surface and is detected by the second sensor, and an inclination of a trailing edge of the sheet that has the image formed on the first surface and is detected by the second sensor, and an inclination of a leading edge of the sheet that has the image formed on the first surface and is detected by the first sensor.

5. The image forming apparatus according to claim 1,
wherein the controller determines a target inclination for a leading edge of the sheet on which an image is to be formed on the second surface by the image forming unit, based on an inclination of a leading edge of the sheet that has the image formed on the first surface and is detected by the second sensor, and an inclination of a trailing edge of the sheet that has the image formed on the first surface and is detected by the second sensor, and
wherein the controller controls the orientation control unit to control the orientation of the sheet on which an image is to be formed on the second surface by the image forming unit, based on the target inclination and an inclination of a leading edge of the sheet that has the image formed on the first surface.

6. The image forming apparatus according to claim 1, further comprising a fixing unit configured to fix the image to the sheet upstream of the switch-back unit in the conveyance direction,
wherein the second sensor is provided between the image forming unit and the fixing unit in the conveyance direction.

7. The image forming apparatus according to claim 1, further comprising a fixing unit configured to fix the image to the sheet upstream of the switch-back unit in the conveyance direction,
wherein the second sensor is provided between the fixing unit and the switch-back unit in the conveyance direction.

8. The image forming apparatus according to claim 1,
wherein the orientation control unit includes a first roller configured to convey the sheet, a second roller that is provided at a position different from that of the first roller in a direction intersecting with the conveyance direction and configured to convey the sheet, a first motor to be used to rotate the first roller, and a second motor to be used to rotate the second roller, and
wherein the orientation control unit controls the orientation of the sheet by individually controlling a rotational speed of the first motor and a rotational speed of the second motor.

9. The image forming apparatus according to claim 1,
wherein the orientation control unit includes a first roller configured to convey the sheet, a second roller that is provided at a position different from that of the first roller in a direction intersecting with the conveyance direction and configured to convey the sheet, a first motor to be used to rotate the first roller, and a second motor to be used to rotate the second roller, and
wherein the orientation control unit controls the orientation of the sheet by controlling a speed difference between a speed of the first roller and a speed of the second roller.

10. The image forming apparatus according to claim 1, further comprising a third sensor configured to detect an edge portion of the sheet in a width direction orthogonal to the conveyance direction while the sheet is conveyed by the first conveyance unit,
wherein the orientation control unit controls a position in the width direction of the sheet conveyed by the first conveyance unit, based on a detection result of the third sensor.

11. The image forming apparatus according to claim 10,
wherein the second sensor is used to detect an edge portion of the sheet in the width direction, and
wherein, in a case where the image forming unit forms an image on the second surface of the sheet, the controller controls a position in the width direction of the sheet on which an image is to be formed on the second surface by the image forming unit, based on a detection result of the edge portion of the sheet that has the image formed on the first surface and is detected by the second sensor, and a detection result of the edge portion of the sheet that has the image formed on the first surface and is detected by the third sensor.

12. The image forming apparatus according to claim 1, further comprising a third sensor configured to detect an edge portion of the sheet in a width direction orthogonal to the conveyance direction while the sheet is conveyed by the first conveyance unit,
wherein the orientation control unit includes a first roller configured to convey the sheet, a second roller that is provided at a position different from that of the first roller in a direction intersecting with the conveyance direction and configured to convey the sheet, a first motor to be used to rotate the first roller, and a second motor to be used to rotate the second roller, and
wherein the orientation control unit controls a position in a width direction orthogonal to the conveyance direction of the sheet conveyed by the first conveyance unit, by controlling a direction in which the first roller and the second roller convey the sheet, based on a detection result of the third sensor.

13. The image forming apparatus according to claim 1,
wherein the second conveyance unit includes a belt configured to suck the sheet, and
wherein the second conveyance unit conveys the sheet to the image forming unit while the sheet of which the orientation is controlled by the orientation control unit is being sucked by the belt.

14. The image forming apparatus according to claim 1,
wherein the second sensor is a line sensor configured to read the sheet while the sheet is conveyed by the second conveyance unit, and
wherein an inclination of a leading edge and an inclination of a trailing edge of the sheet in the conveyance direction are detected based on a read image of the sheet read by the line sensor.

15. The image forming apparatus according to claim 1,
wherein the second sensor acquires a shape of the sheet while the sheet is conveyed by the second conveyance unit, and
wherein an inclination of a leading edge and an inclination of a trailing edge of the sheet in the conveyance direction are detected based on the shape of the sheet.

16. The image forming apparatus according to claim 2, further comprising a drying unit configured to dry the image on the sheet in the conveyance direction downstream of a position at which the recording head forms the image, and
wherein the second sensor detects the sheet at a position between the recording head and the drying unit in the conveyance direction.

17. The image forming apparatus according to claim 2, further comprising a fixing unit configured to fix the image to the sheet in the conveyance direction downstream of a position at which the recording head forms the image, and
wherein the second sensor detects the sheet at a position between the fixing unit and the switch-back unit in the conveyance direction.

18. The image forming apparatus according to claim 1, wherein, before an image is formed on the first surface of the sheet by the image forming unit, the controller controls the orientation of the sheet based on an inclination of a leading edge in the conveyance direction of the sheet detected by the first sensor.

19. A method for controlling the orientation of a sheet on which an image is to be formed by an image forming apparatus, the method comprising:
conveying the sheet via a first conveyancing unit;
forming an image on the sheet conveyed by the first conveyancing unit;
detecting the sheet while the sheet is conveyed by the first conveyance unit via a first sensor, the first sensor detecting an inclination of a leading edge of the sheet in a conveyance direction in which the sheet is conveyed;
conveying the sheet on which an image is formed via a second conveyance unit;
detecting the sheet on which the image is formed while being conveyed by the second conveyance unit via a second sensor, the second sensor being used to detect an inclination of a leading edge and an inclination of a trailing edge of the sheet in the conveyance direction;
switching-back the sheet, wherein the sheet is switched-back downstream of the second sensor in the conveyance direction in which the sheet is conveyed;
conveying the switched back sheet via a third conveyance unit, the third conveyance unit conveying the switched back sheet to the first conveyance unit in a case where images are to be formed on both surfaces of the sheet;
controlling the second sensor to detect the sheet after an image is formed on a first surface of the sheet;
controlling the first sensor to detect the sheet conveyed by the third conveyance unit and the first conveyance unit; and
in a case where an image is to be formed on a second surface of the sheet, controlling the orientation of the sheet on which an image is to be formed on the second surface, based on an inclination of a leading edge of the sheet that has the image formed on the first surface and is detected by the second sensor, an inclination of a trailing edge of the sheet that has the image formed on the first surface and is detected by the second sensor, and an inclination of a leading edge of the sheet that has the image formed on the first surface and is detected by the first sensor.

20. A computer-readable data carrier having stored thereon a computer program comprising instructions which, when the program is executed by an image forming apparatus, cause the image forming apparatus to carry out the method of claim 19.
